(19) United States
(12) Patent Application Publication
(10) Pub. No.: US 2021/0399443 A1
(43) Pub. Date: Dec. 23, 2021

(54) WIRE CONNECTION STRUCTURE AND WIRE CONNECTION METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuji KAWATA, Mie (JP); Kenji MIYAMOTO, Mie (JP); Tatsuo TAMAGAWA, Mie (JP); Daichi SHIRAI, Mie (JP)

(21) Appl. No.: 17/288,016

(22) PCT Filed: Oct. 4, 2019
(86) PCT No.: PCT/JP2019/039244

§ 371 Date: Apr. 23, 2021

(30) Foreign Application Priority Data
Oct. 25, 2018 (JP) 2018-200805

(51) Int. Cl. H01R 4/62; H01R 43/02

(52) U.S. Cl. CPC H01R 4/625; H01R 43/0207

(57) ABSTRACT

A harness 1 includes copper wires 10A and aluminum wires 10B. The copper wire 10A includes a copper core 11A. The aluminum wire 10B includes an aluminum core 11B made of a material different from that of the copper core 11A and having lower conductor strength than the copper core 11A. The copper cores 11A are multiply folded, and parts on tip sides serve as a bulky portion 11AE. The harness 1 includes a joined portion 20 formed by welding the copper cores 11A including the joined portion 11AE and the aluminum cores 11B. The joined portion 20 includes a first layer 21 constituted by the copper cores 11A including the bulky portion 11AE and a second layer 22 constituted by the aluminum cores 11B and overlaid on the first layer 21.

### TECHNICAL FIELD

A technique disclosed by this specification relates to a wire connection structure and a wire connection method.

### BACKGROUND

A wire connection structure is known in which cores of a plurality of wires are joined. A core joining method is, for example, a method for bundling and twisting cores of a plurality of wires and joining the cores by ultrasonic welding (see Patent Document 1).

### PRIOR ART DOCUMENT

### Patent Document

Patent Document 1: JP 2005-322544 A

### SUMMARY OF THE INVENTION

### Problems to be Solved

In the joining method as described above, if two types of wires different in core material are joined, problems such as the peeling of joined parts due to insufficient joining strength may occur. Thus, there has been a demand for improvement.

### Means to Solve the Problem

A wire connection structure disclosed by this specification includes first wires each including a first core, second wires each including a second core made of a material different from that of the first core and having lower conductor strength than the first core, a bulky portion made of the same type of material as the first cores, and a joined portion formed by welding the first cores, the second cores and the bulky portion, wherein the joined portion includes a first layer constituted by the first cores and the bulky portion and a second layer constituted by the second cores and overlaid on the first layer.

Further, a wire connection method disclosed by this specification is a method for connecting first wires each including a first core and second wires each including a second core made of a material different from that of the first core and having lower conductor strength than the first core, the wire connection method including a first welding step of forming a first layer by ultrasonically welding the first cores and a bulky portion made of the same type of material as the first cores, and a second welding step of forming a second layer by placing the second cores on the first layer and ultrasonically welding the first layer and the second cores.

According to the above configurations, since the first layer is made bulky by the bulky portion, the first layer can be made into a uniform layer having certain width and thickness at the time of welding, and the second layer overlaid on this first layer can also be made into a uniform layer. In this way, a variation in welding strength can be suppressed and sufficient joining strength can be ensured.

In the above configurations, the bulky portion may be constituted by parts of the multiply folded first cores. Alternately, the bulky portion may be a bulky member separate from the first cores.

### Effect of the Invention

According to the wire connection structure and the wire connection method disclosed by this specification, sufficient joining strength can be ensured when a plurality of wires different in core material are joined.

### BRIEF DESCRIPTION OF THE DRAWINGS

FIG. 1 is a side view of a harness of a first embodiment.

FIG. 2 is a section along A-A of FIG. 1.

FIG. 3 is a side view showing a state where copper cores are folded and set on an anvil in the first embodiment.

FIG. 4 is a side view showing a state where the copper cores are ultrasonically welded to form a first layer in the first embodiment.

FIG. 5 is a section along B-B of FIG. 4.

FIG. 6 is a side view showing a state where aluminum cores are placed on the first layer in the first embodiment.

FIG. 7 is a side view showing a state where the aluminum cores are ultrasonically welded to form a second layer in the first embodiment.

FIG. 8 is a section along C-C of FIG. 7.

FIG. 9 is a side view showing a state where copper cores and a dummy core are set on an anvil in a second embodiment.

FIG. 10 is a side view showing a state where the copper cores and the dummy core are ultrasonically welded to form a first layer in the second embodiment.

FIG. 11 is a side view showing a state where aluminum cores are placed on the first layer in the second embodiment.

FIG. 12 is a side view showing a state where the aluminum cores are ultrasonically welded to form a second layer in the second embodiment.

FIG. 13 is a side view showing a state where copper cores are ultrasonically welded to form a first layer in a conventional example.

FIG. 14 is a section along D-D of FIG. 13.

FIG. 15 is a section cut at the same position as line D-D of FIG. 13 showing a state where aluminum cores are placed on the first layer and ultrasonically welded to form a second layer in the conventional example.

### DETAILED DESCRIPTION TO EXECUTE THE INVENTION

### First Embodiment

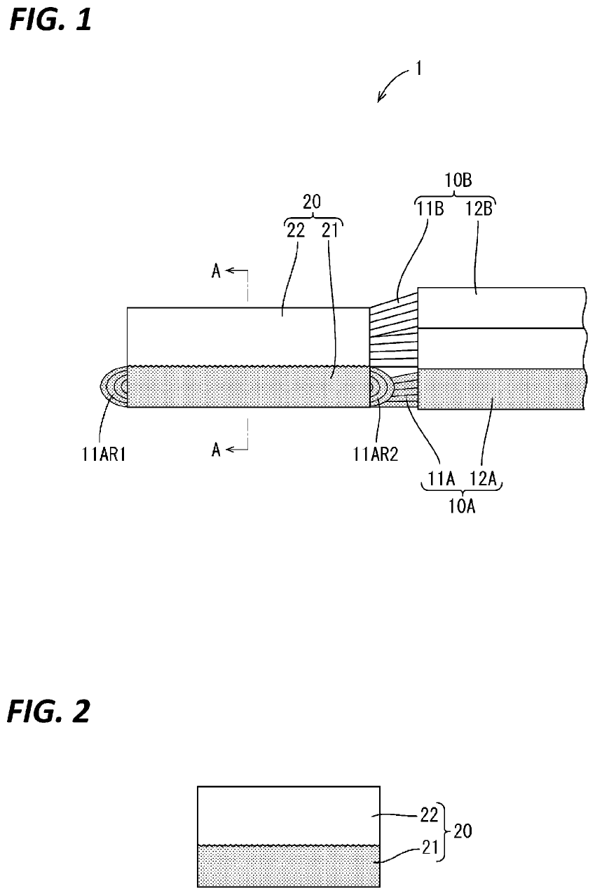

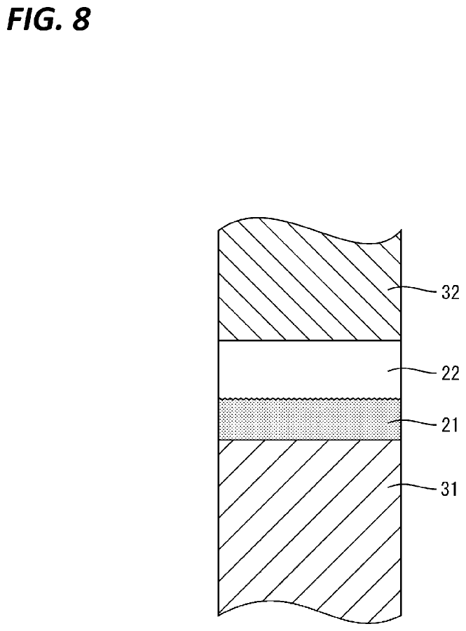

A first embodiment is described with reference to FIGS. 1 to 8. A wire connection structure of this embodiment is a part of a harness 1 in which a plurality of copper wires 10A (corresponding to first wires) and a plurality of aluminum cores 10B (corresponding to second wires) are connected.

As shown in FIG. 1, the copper wire 10A includes a copper core 11A (corresponding to first cores) constituted by a stranded wire formed by twisting a plurality of strands made of copper, and a first insulation coating 12A made of synthetic resin for covering the copper core 11A. The copper core 11A has a part exposed from the first insulation coating 12A in an end part of the copper wire 10A.

As shown in FIG. 1, the aluminum wire 10B includes an aluminum core 11B (corresponding to second cores) constituted by a stranded wire formed by twisting a plurality of strands made of aluminum, and a second insulation coating 12B made of synthetic resin for covering the aluminum core 11B. The aluminum core 11B has a part exposed from the second insulation coating 12B in an end part of the aluminum wire 10B.

The aluminum core 11B has lower conductor strength than the copper core 11A.

Here, the “conductor strength” means tensile strength of the core. More specifically, the “conductor strength” means a value obtained by dividing a maximum load reached before fracture by a core cross-sectional area before loading when a tensile test is conducted for the core in accordance with “JIS Z 2241”.

The plurality of copper cores 11A and the plurality of aluminum cores 11B are joined to each other to constitute a joined portion 20.

As shown in FIG. 1, the joined portion 20 includes two layers, i.e. a first layer 21 and a second layer 22 overlaid on the first layer 21. The first layer 21 is a layer constituted by the plurality of copper cores 11A, and the second layer 22 is a layer constituted by the plurality of aluminum cores 11B. The lowermost layer (an example of one outermost layer) is formed only by the first layer 21 and the uppermost layer (an example of another outermost layer) is formed only by the second layer 22 in a vertical direction (an example of a lamination direction) in FIG. 1.

The exposed parts of the plurality of copper cores 11A are folded twice in a bundled state and joined in a state folded into an S shape. The folded parts of the copper cores 11A at two positions respectively become U-shaped loop portions 11AR1, 11AR2 slightly bulging out from both ends of the first layer 21.

An example of a method for manufacturing the harness 1 having the above configuration is described below.

First, in the end part of each of the plurality of copper wires 10A, the first insulation coating 12A is stripped to expose the copper core 11A. Similarly, the second insulation coating 12B is stripped to expose the aluminum core 11B in the end part also for each of the plurality of aluminum wires 10B. A stripping length of the copper wire 10A is about three times as long as that of the aluminum wire 10A.

Subsequently, the exposed parts of the copper cores 11A and the aluminum cores 11B are joined using an ultrasonic welding apparatus 30. The ultrasonic welding apparatus 30 is an apparatus having a known configuration including an anvil 31 and a welding horn 32.

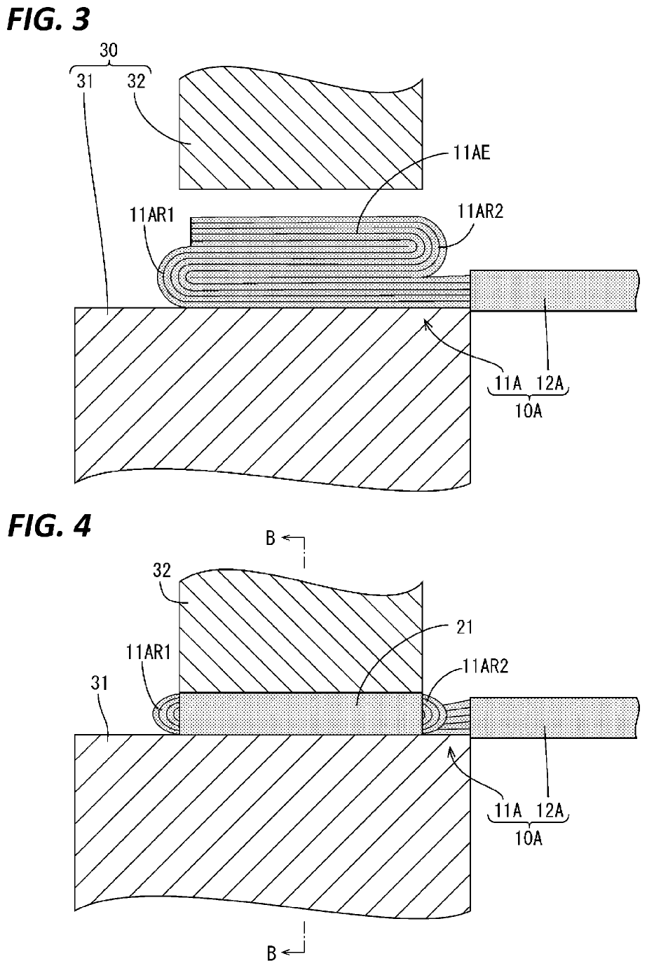

First, the first layer 21 is formed (first welding step). The exposed parts of the plurality of copper cores 11A are bundled into one. Subsequently, the bundle of the copper cores 11A is folded at two folding positions (loop portions 11AR1, 11AR2) into three layers and placed on the anvil 31 as shown in FIG. 3. In the copper cores 11A, parts closer to one (left in FIG. 3) loop portion 11AR1 serve as a bulky portion 11AE.

Subsequently, the welding horn 32 is lowered and ultrasonic vibration along an axial direction of the copper wires 10A is applied while the copper cores 11A are pressed. Welding conditions are set to be suitable for the copper cores 11A. In this way, as shown in FIG. 4, the plurality of copper cores 11A are welded to form the first layer 21.

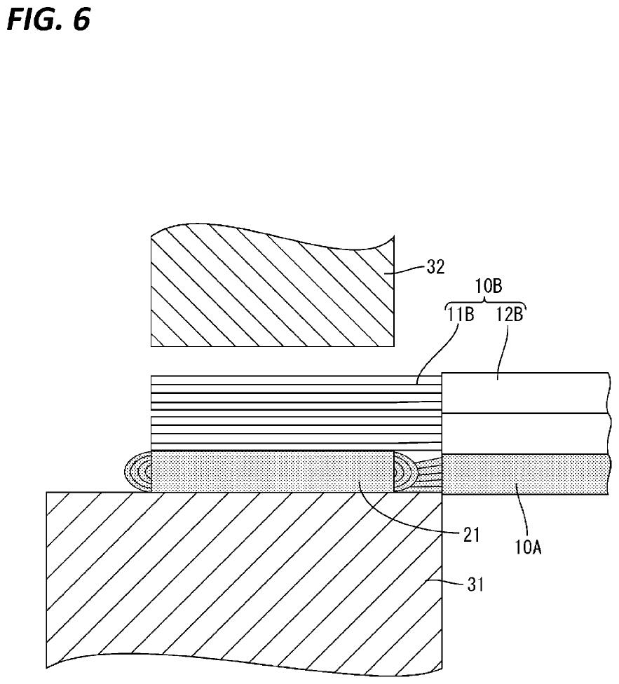

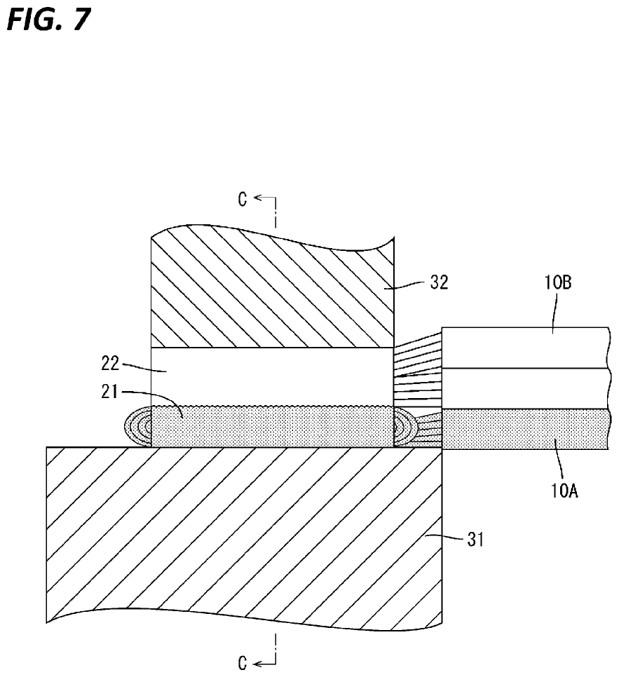

Subsequently, the second layer 22 is formed (second welding step). The welding horn 32 is raised and the plurality of aluminum cores 11B are placed on the formed first layer 21 as shown in FIG. 6. Subsequently, the welding horn 32 is lowered and ultrasonic vibration along an axial direction of the aluminum wires 10B is applied while the aluminum cores 11B are pressed toward the first layer 21. Welding conditions are set to be suitable for the aluminum cores 11B. In this way, as shown in FIG. 7, the plurality of aluminum cores 11B are welded on the first layer 21 to form the second layer 22.

In this way, the harness 1 is completed.

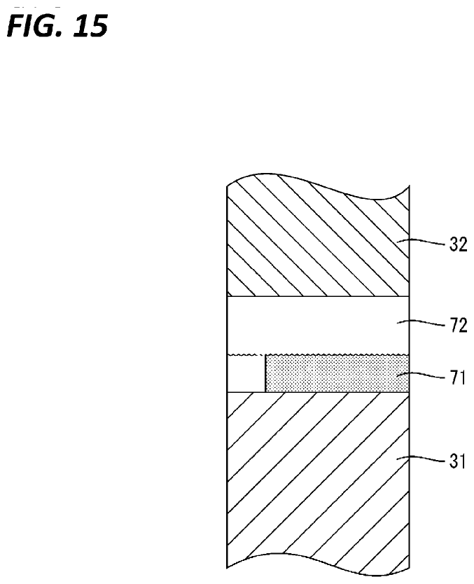

Here, if a relatively small number of the copper cores 11A are welded, a first layer 71 formed in the first welding step may not spread over the entire width of the anvil 31 as shown in FIG. 14. In such a case, in the second welding step, a part of a second layer 72 bulges laterally to the first layer 71 as shown in FIG. 15. Since a lower load is applied to the part of the second layer 72 bulging laterally to the first layer 71 (left end part of FIG. 15) by the welding horn 32, welding is insufficient. Since a higher load is applied to a part placed on the first layer 71, welding is excessive. As just described, welding strength varies on an interface between the first and second layers 71 and 72 and may become unstable.

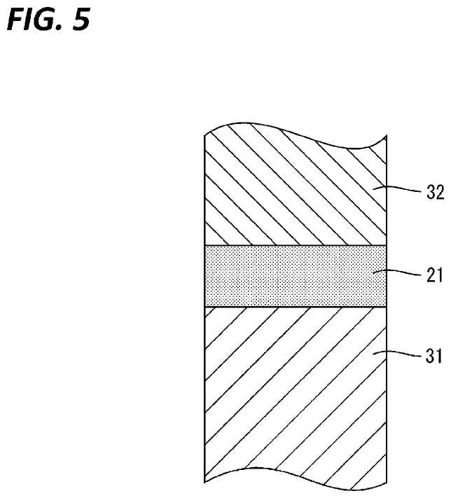

In contrast, in the method for manufacturing the harness 1 of this embodiment, the copper cores 11A are folded into three layers and the welded part is made bulkier than when the copper cores 11A are not folded. Thus, as shown in FIG. 5, the first layer 21 formed in the first welding step spreads over the entire widths of the anvil 31 and the welding horn 32 and becomes a uniform layer having certain width and thickness. In this way, it can be avoided that the second layer 22 overlaid on the first layer 21 in the second welding step bulges laterally to the first layer 21, and the second layer 22 can be made into a uniform layer. In this way, a variation in welding strength can be suppressed.

As described above, according to this embodiment, the harness 1 includes the copper wires 10A and the aluminum wires 10B. The copper wire 10A includes the copper core 11A. The aluminum wire 10B includes the aluminum core 11B made of the material different from that of the copper core 11A and having lower conductor strength than the copper core 11A. The copper cores 11A are multiply folded and parts thereof serve as the bulky portion 11AE. The harness 1 includes the joined portion 20 formed by welding the copper cores 11A including the bulky portion 11AE and the aluminum cores 11B. The joined portion 20 is composed of the first layer 21 constituted by the copper cores 11A including the bulky portion 11AE and the second layer 22 constituted by the aluminum wires 11B and overlaid on the first layer 21.

Further, the method for manufacturing the harness 1 of this embodiment is a method for connecting the copper wires 10A including the copper cores 11A and the aluminum wires 10B including the aluminum cores 11B made of the material different from that of the copper cores 11A and having lower conductor strength than the copper cores 11A, and includes the first welding step and the second welding step. The first welding step is a step of forming the first layer 21 by multiply folding the copper cores 11A so that the parts closer to the tip sides than the folding position (loop portion 11AR1) serve as the bulky portion 11AE and ultrasonically welding the copper cores 11A including this bulky portion 11AE. The second welding step is a step of forming the second layer 22 by placing the aluminum cores 11B on the first layer 21 and ultrasonically welding the first layer 21 and the aluminum cores 11B.

According to the above configuration, since the first layer 21 is made bulky by the bulky portion 11AE, the first layer 21 can be made into a uniform layer having certain width and thickness at the time of welding. The second layer 22 overlaid on the first layer 21 can also be made into a uniform layer. In this way, a variation in welding strength can be suppressed, and sufficient joining strength can be ensured.

### Second Embodiment

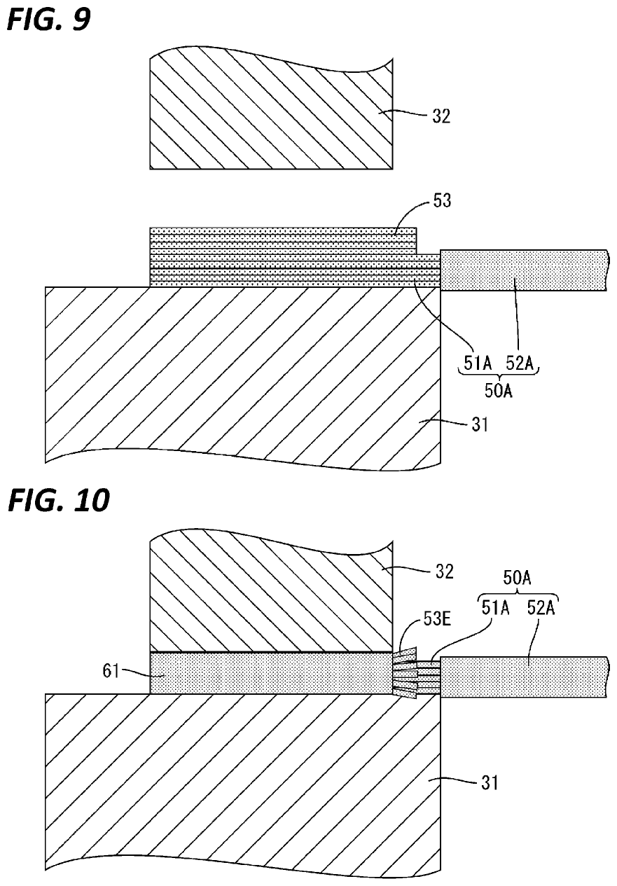

Next, a second embodiment is described with reference to FIGS. 9 to 12. A harness 40 of this embodiment includes a plurality of copper wires 50A (corresponding to the first wires), a plurality of aluminum wires 10B and a dummy core 53 (corresponding to a bulky portion and a bulky member).

The copper wire 50A includes a copper core 51A (corresponding to the first cores) and a first insulation coating 52A (FIG. 12), similarly to the copper wire 10A of the first embodiment. The copper core 51A has a part exposed from the first insulation coating 52A.

The dummy core 53 is constituted by a stranded wire formed by twisting a plurality of strands made of the same material as the copper core 51A, i.e. copper, and has a length substantially equal to the exposed parts of the copper cores 51A (see FIG. 9).

The copper cores 51, aluminum cores 11B and the dummy core 53 are ultrasonically welded to constitute a joined portion 60.

As shown in FIG. 12, the joined portion 60 includes two layers, i.e. a first layer 61 and a second layer 22 overlaid on the first layer 61. The first layer 61 is a layer constituted by the plurality of copper cores 51A and the dummy core 53, and the second layer 22 is a layer constituted by a plurality of the aluminum cores 11B. An end of the dummy core 53 slightly bulges from the first layer 21 and serves as a disconnection portion 53E connected to neither the copper wires 50A nor the aluminum wires 10B.

An example of a method for manufacturing the harness 40 having the above configuration is described below.

First, the first layer 61 is formed (first welding step). As shown in FIG. 9, the exposed parts of the plurality of copper cores 51A and the dummy core 53 are bundled into one and placed on an anvil 31 of a welding horn 30. Subsequently, a welding horn 32 is lowered and ultrasonic vibration along an axial direction of the copper wires 50A is applied while the copper cores 51A and the dummy core 53 are pressed. Welding conditions are set to be suitable for the copper cores 51A. In this way, as shown in FIG. 10, the copper cores 51A and the dummy core 53 are welded to form the first layer 61.

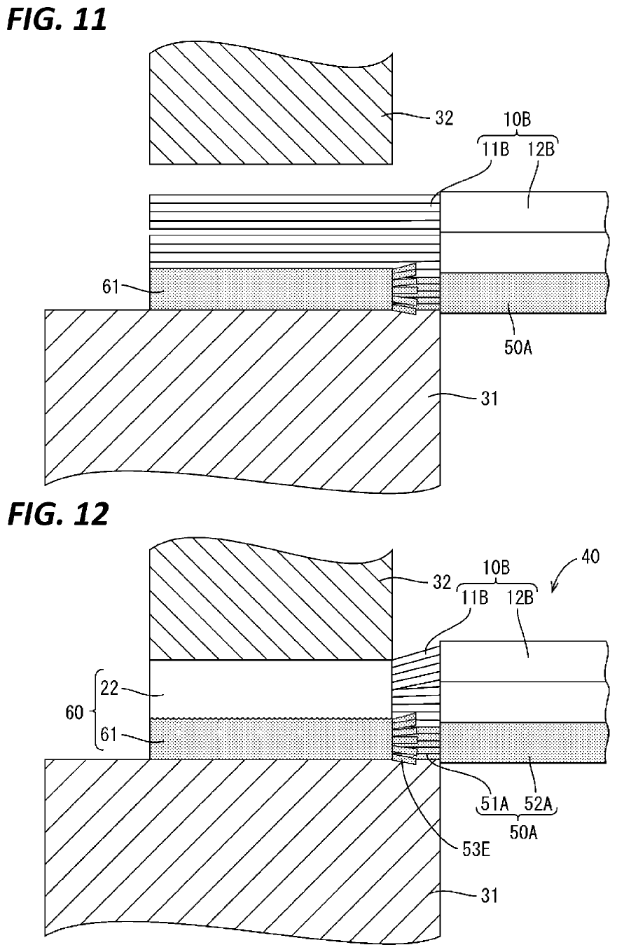

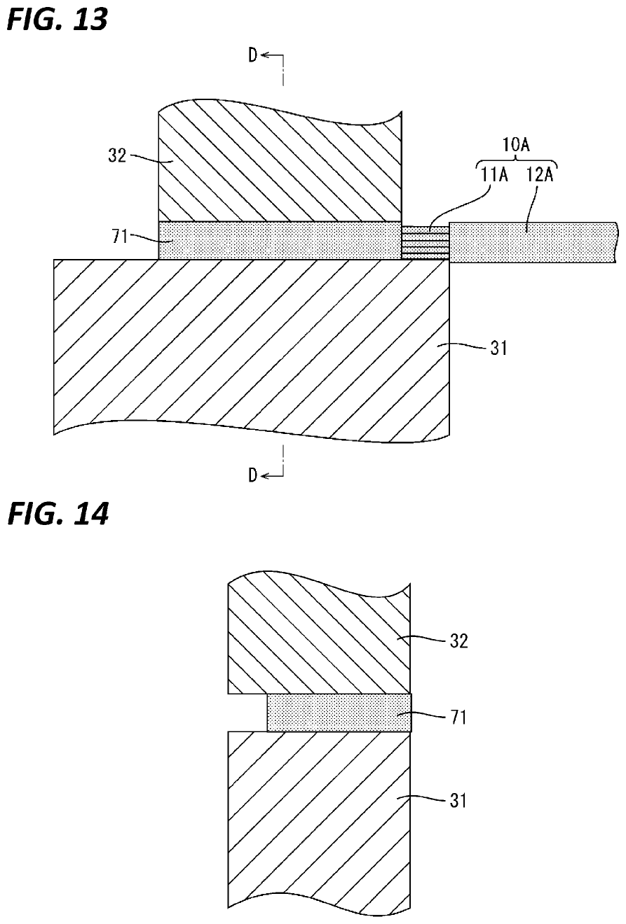

Subsequently, the second layer 22 is formed (second welding step). The welding horn 32 is raised and the exposed parts of the plurality of aluminum cores 11B are placed on the first layer 61 as shown in FIG. 11. Subsequently, the welding horn 32 is lowered and ultrasonic vibration along an axial direction of the aluminum wires 10B is applied while the first layer 61 and the aluminum cores 11B are pressed. Welding conditions are set to be suitable for the aluminum cores 11B. In this way, as shown in FIG. 12, the aluminum cores 11B are welded on the first layer 61 to form the second layer 22.

In this way, the harness 1 is completed.

Since a welded part is made bulky by the dummy core 53 in the first welding step, the first layer 61 formed by welding spreads over the entire widths of the anvil 31 and the welding horn 32 and becomes a unfirm layer as in the first embodiment. In this way, it can be avoided that the second layer 22 overlaid on the first layer 61 in the second welding step bulges laterally to the first layer 61, and the second layer 22 can be made into a uniform layer. In this way, a variation in welding strength can be suppressed.

As described above, functions and effects similar to those of the first embodiment can be achieved also by this embodiment.

### Other Embodiments

The technique disclosed by this specification is not limited to the above described and illustrated embodiments. For example, the following various modes are also included.

(1) Although the copper cores 11A are folded at two positions into three layers in the first embodiment, the first cores may be folded once into two layers or folded three or more times into four or more layers.

(2) Although the dummy core 53 is not multiply folded in the second embodiment, the bulky member may be multiply folded.

(3) Although the bulky member is the dummy core 53 in the second embodiment, the type of the bulky member is not limited to that in the above embodiment. For example, the bulky member may be a bar-like or plate-like member made of the same type of material as the first cores.

### LIST OF REFERENCE NUMERALS

1, 40 . . . harness (wire connection structure)
10A, 50A . . . copper wire (first wire)
10B . . . aluminum wire (second wire)
11A, 51A . . . copper core (first core)
11AE . . . bulky portion
11B . . . aluminum core (second core)
20, 60 . . . joined portion
21, 61 . . . first layer
22 . . . second layer
53 . . . dummy core (bulky portion, bulky member)

1. A wire connection structure, comprising:
first wires each including a first core;
second wires each including a second core made of a material different from that of the first core and having lower conductor strength than the first core;
a bulky portion made of the same type of material as the first cores, and
a joined portion formed by welding the first cores, the second cores and the bulky portion,
wherein:
the joined portion includes a first layer constituted by the first cores and the bulky portion and a second layer constituted by the second cores and overlaid on the first layer,
the first layer serving as one layer is constituted by the first cores and the bulky portion, and
the first cores are relatively smaller in number than the second cores.

2. The wire connection structure of claim 1, wherein one outermost layer is formed only by the first layer and another outermost layer is formed only by the second layer in a lamination direction of the first and second layers.

3. The wire connection structure of claim 1, wherein the bulky portion is constituted by parts of the multiply folded first cores.

4. The wire connection structure of claim 1, wherein the bulky portion is a bulky member separate from the first cores.

5. A wire connection method for connecting first wires each including a first core and second wires each including a second core made of a material different from that of the first core and having lower conductor strength than the first core, comprising:
a first welding step of forming a first layer by ultrasonically welding the first cores and a bulky portion made of the same type of material as the first cores; and
a second welding step of forming a second layer by placing the second cores on the first layer and ultrasonically welding the first layer and the second cores.
